(19) United States
(12) Patent Application Publication
(10) Pub. No.: US 2022/0153632 A1
(43) Pub. Date: May 19, 2022

(54) METHOD OF FORMING THROUGH HOLE IN GLASS

(71) Applicant: CORNING INCORPORATED, CORNING, NY (US)

(72) Inventor: Patrick Scott Leslie, Tucson, AZ (US)

(21) Appl. No.: 17/439,541

(22) PCT Filed: Mar. 20, 2020
(86) PCT No.: PCT/US2020/023887

§ 371 Date: Sep. 15, 2021

Related U.S. Application Data
(60) Provisional application No. 62/823,232, filed on Mar. 25, 2019.

(51) Int. Cl. C03C 15/00; C03C 23/00; B23K 26/382; B23K 26/402

(52) U.S. Cl. CPC C03C 15/00; C03C 23/001; B23K 2103/54; B23K 26/402; B23K 26/382

(57) ABSTRACT

A method of forming a through hole in a glass substrate is provided. The method includes irradiating a surface of a glass substrate with a mid-infrared or far-infrared laser to form a pilot hole including a plurality of cracks extending radially outward from the pilot hole. The pilot hole is etched to expand a diameter of the pilot hole to at least encompass the plurality of cracks to form a through hole having a through hole entry diameter of about 200 micrometers to about 1.5 millimeters.

### CROSS-REFERENCE TO RELATED APPLICATIONS

This application claims the benefit of priority under 35 U.S.C. § 119 of U.S. Provisional Application No. 62/823,232, filed Mar. 25, 2019, the content of which is incorporated herein by reference in its entirety.

### FIELD

The present disclosure generally relates to a method for forming a through hole in a glass substrate, and particularly to a method for forming an array of through holes in a glass substrate utilized in electronics packaging. More specifically, the present disclosure relates to a method using a combination of laser processing and etching to form a through hole in glass.

### BACKGROUND

Glass substrates are often utilized in electronics packaging, such as semiconductor packaging, for example. The glass substrates used in electronics packaging typically require holes to be formed extending through the glass substrate, referred to as through holes or through glass vias (TGV), for use in creating electrical interconnects and other functional features. There are multiple different ways to form through holes in glass, including laser ablation, chemical etching, mechanical drilling, and pressing. Each of these methods face their own challenges for forming through holes in an efficient and reliable manner suitable for mass production. Laser ablation, for example, often requires careful selection of parameters such as laser wavelength, ablation time, laser pulse train settings, and beam shaping, to produce through holes in the glass substrate without forming cracks in the substrate that may render the substrate unusable. As the dimensions of the through hole increase, the time required for the formation of the through holes utilizing laser ablation can also increase and may become time prohibitive for some large scale production purposes. In addition, many laser ablation methods for forming arrays of through holes utilize complex lens and position control equipment, which can be costly to purchase and maintain. Another through hole forming method, chemical etching, requires the use of a chemical treatment to etch away the substrate materials. The etching process requires the substrate to be exposed to a chemical etchant, sometimes for long periods of time depending on the dimensions of the through hole being formed. During the etching process, both the through hole and the bulk substrate material is etched, which results in the use of thicker starting substrates to compensate for this bulk material loss.

In view of these considerations, there is a need for a method of forming through holes in glass, particularly large through holes having any entry diameter of about 200 micrometers to about 1.5 millimeters, in a manner suitable for mass production and with less loss of material.

### SUMMARY

According to an aspect of the present disclosure, a method of forming a through hole in a glass substrate is provided. The method includes providing a glass substrate having a first surface, a second surface, and a thickness extending between the first surface and the second surface. The first surface is irradiated with a mid-infrared or far-infrared laser to form a pilot hole extending between the first surface and the second surface. The glass substrate includes a plurality of cracks extending radially outward from the pilot hole. The pilot hole is etched to expand a diameter of the pilot hole to at least encompass the plurality of cracks extending radially outward from the pilot hole. The etched pilot holes form a through hole characterized by a through hole entry diameter of about 200 micrometers to about 1.5 millimeters.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a flow chart illustrating a method of forming a through hole in a glass substrate, according to an aspect of the present disclosure;

FIG. 2 is a schematic illustration of the method of FIG. 1 for forming a through hole in a glass substrate, according to an aspect of the present disclosure;

FIG. 3 is an image of a perspective view of a through hole having a plurality of radially extending cracks, according to an aspect of the present disclosure;

FIG. 4 is an image of a top-down view of a through hole having a plurality of radially extending cracks, according to an aspect of the present disclosure;

FIG. 5 is an image of a perspective view of a through hole formed according to a prior art method that is free of cracks;

FIG. 6 is an image of a perspective view of a through hole formed according to a prior art method that is free of cracks;

FIG. 7A is a top-down image of a through hole having a plurality of radially extending cracks, according to an aspect of the present disclosure;

FIG. 7B is a bottom-up image of the through hole of FIG. 7A, according to an aspect of the present disclosure;

FIG. 8 is a top-down image of a through hole having a plurality of radially extending cracks, according to an aspect of the present disclosure; and

FIG. 9 is a top-down image of a through hole having a plurality of radially extending cracks, according to an aspect of the present disclosure.

### DETAILED DESCRIPTION

Aspects of the present disclosure relate to forming through holes, also referred to as through glass vias (TGV) or simply vias, through a glass substrate utilizing a mid-infrared or far-infrared laser to form pilot holes in the glass substrate. The pilot holes are then expanded to their final diameter by exposing the pilot holes to an etchant. The glass substrate is irradiated with the laser in such a manner as to produce cracks in the glass extending radially outward from the pilot hole. The glass substrate is then exposed to an etchant to expand a diameter of the pilot hole by etching the glass around the pilot hole to at least encompass the cracks extending outward from the pilot hole. In this manner, large through holes on the order of about 200 micrometers to about 1.5 millimeters can be formed in a glass substrate.

In the following detailed description, for purposes of explanation and not limitation, example aspects disclosing specific details are set forth to provide a thorough understanding of various principles of the present disclosure. However, it will be apparent to one having ordinary skill in the art, having had the benefit of the present disclosure, that the present disclosure may be practiced in other aspects that depart from the specific details disclosed herein. Moreover, descriptions of well-known devices, methods and materials may be omitted so as not to obscure the description of various principles of the present disclosure. Finally, wherever applicable, like reference numerals refer to like elements.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

For purposes of this disclosure, the terms “bulk,” “bulk composition” and/or “overall compositions” are intended to include the overall composition of the entire article, which may be differentiated from a “local composition” or “localized composition” which may differ from the bulk composition owing to the formation of crystalline and/or ceramic phases.

The term “formed from” can mean one or more of comprises, consists essentially of, or consists of. For example, a component that is formed from a particular material can comprise the particular material, consist essentially of the particular material, or consist of the particular material.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As also used herein, the terms “substrate,” “glass substrate,” “glass-ceramics substrate,” “glass elements,” and “glass” may be used interchangeably, and in their broadest sense, to include any object made wholly or partly of glass and/or a glass-ceramic material.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

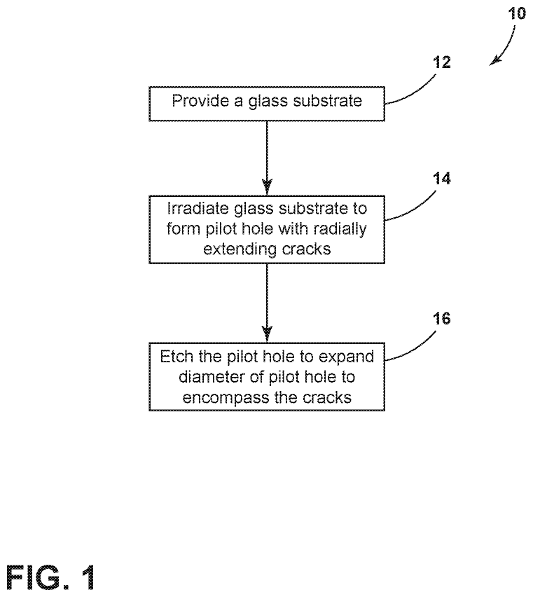

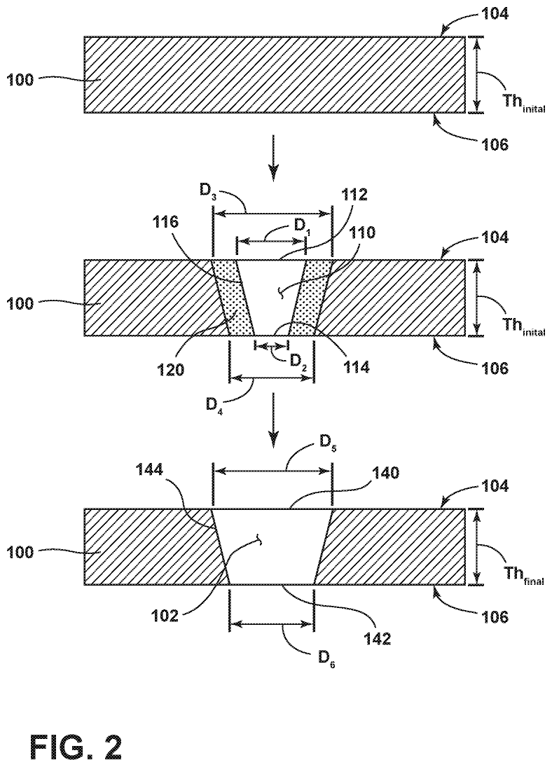

Referring now to FIGS. 1 and 2, a method 10 for forming a through hole in a glass substrate according to an aspect of the present disclosure is illustrated. While the method 10 is discussed in the context of forming a single through hole, it is understood that aspects of the method 10 can be utilized to form an array of through holes in a glass substrate, as is discussed in further detail below. Generally, the method includes providing a glass substrate at step 12, irradiating the glass substrate to form a pilot hole with radially extending cracks at step 14, and an etching process at step 16 in which the glass substrate is exposed to an etchant to expand the diameter of the pilot hole formed in step 14 by etching the pilot hole to at least encompass the cracks radially extending from the pilot hole. As used herein, the term “pilot hole” refers to an initial hole formed by laser ablation which undergoes additional processing to enlarge at least one dimension of the pilot hole to form the through hole.

Referring now to FIG. 2, a glass substrate 100 in which a through hole 102 or an array of through holes 102 is to be formed can be any suitable material wholly or partly formed of glass. In one aspect, the glass substrate 100 can be any one of chemically strengthened glass, soda lime glass, alkali aluminosilicate glass, germanium glass, alkaline earth boro-aluminosilicate glass, alkali borosilicate glass, calcium fluoride glass, and magnesium fluoride glass. In some aspects, the glass substrate 100 may include both a glassy phase and a ceramic phase. The glass substrate 100 includes a first surface 104 and an opposing second surface 106, which together define an initial thickness Thᵢₙᵢₜᵢₐₗ of the glass substrate 100. The glass substrate 100 may have a selected length and width to define its surface area. The glass substrate 100 can have an initial thickness Thᵢₙᵢₜᵢₐₗ of about 0.4 millimeters (mm) to about 3 mm. In some aspects, the glass substrate 100 has an initial thickness Thᵢₙᵢₜᵢₐₗ of about 0.4 mm to about 2 mm, about 0.4 mm to about 1.1 mm, about 0.7 mm to about 3 mm, 0.7 mm to about 2 mm, about 0.7 to about 1.1 mm, about 1.1 mm to about 3 mm, about 1.1 mm to about 2 mm, or about 2 mm to about 3 mm. The glass substrate 100 can have any length and width suitable for forming individual holes or an array of holes. In one example, the glass substrate 100 can have a length and width of 500 mm by 500 mm.

With reference again to FIGS. 1 and 2, at step 14, the first surface 104 is irradiated with a laser beam to form a pilot hole 110 extending through the glass substrate 100. The pilot hole 110 can be defined by a pilot hole entry 112 in the first surface 104, a pilot hole exit 114 in the second surface 106, and a pilot hole sidewall 116 extending between the pilot hole entry 112 and the pilot hole exit 114. A length of the pilot hole 110 corresponds to the initial thickness Thᵢₙᵢₜᵢₐₗ of the glass substrate 100. The pilot hole entry 112 is defined by an entry diameter D₁ and the pilot hole exit 114 is defined by an exit diameter D₂ with respect to a central axis of the pilot hole 110. The exit diameter D₂ may be the same or different than the entry diameter D₁. In one aspect, the entry diameter D₁ of the pilot hole 110 can be about 150 micrometers (μm) to about 1000 μm, about 150 μm to about 750 μm, about 150 μm to about 500 μm, about 150 μm to about 250 μm, about 200 μm to about 1000 μm, about 200 μm to about 750 μm, about 200 μm to about 500 μm, about 250 μm to about 1000 μm, about 250 μm to about 750 μm, about 250 μm to about 500 μm, about 300 μm to about 1000 μm, about 300 μm to about 750 μm, about 300 μm to about 500 μm, about 300 μm to about 400 μm, or about 500 μm to about 1000 μm. In one aspect, the entry diameter D₁ of the pilot hole 110 is about 150 μm, about 200 μm, about 250 μm, about 300 μm, about 350 μm, or about 500 μm. In one aspect, the exit diameter D₂ of the pilot hole 110 can be about 50 μm to about 500 μm, about 50 μm to about 400 μm, about 50 μm to about 300 μm, about 50 μm to about 200 μm, about 50 μm to about 100 μm, about 100 μm to about 500 μm, about 100 μm to about 400 μm, about 100 μm to about 300 μm, about 100 μm to about 200 μm, about 200 μm to about 500 μm, about 200 μm to about 400 μm, about 200 μm to about 300 μm, about 300 μm to about 500 μm, about 300 μm to about 400 μm, or about 400 μm to about 500 μm, in combination with any of the values or ranges of the entry diameter D₁ of the present disclosure.

A cross-sectional shape of the pilot hole 110 can vary based on a number of factors known in the field of through hole laser ablation, non-limiting examples of which include the components of the glass substrate 100, the initial thickness Th natal of the glass substrate 100, and one or more parameters of the laser beam during irradiation at step 14 (e.g., laser wavelength, laser power, and laser pulse train settings). According to one aspect, the sidewall 116 may extend between the pilot hole entry 112 and the pilot hole exit 114 at an angle of about 90 degrees with respect to the first surface 104 or at an angle greater than about 90 degrees with respect to the first surface 104 such that the sidewall 116 tapers between the pilot hole entry 112 and the pilot hole exit 114 (as shown in FIG. 2). In one aspect, the sidewall 116 extends between the pilot hole entry 112 and the pilot hole exit 114 at an angle with respect to the first surface 104 of greater than about 90 degrees, about 90 degrees to about 120 degrees, about 90 degrees to about 110 degrees, about 90 degrees to about 100 degrees, about 90 degrees to about 95 degrees, about 95 degrees to about 120 degrees, about 95 degrees to about 110 degrees, or about 95 degrees to about 100 degrees.

Still referring to FIGS. 1 and 2, the glass substrate 100 is irradiated at step 14 to form the pilot hole 110 such that a plurality of cracks extend radially outward from the pilot hole 110. The cracks can be formed in the first surface 104, the second surface 106, and/or extend from the sidewall 116 anywhere along the length of the pilot hole 110. The cracks can be uniform or non-uniform in shape, dimension, and spacing, and may extend through the glass substrate 100 parallel and/or perpendicular to the central axis of the pilot hole 110 anywhere along the length of the pilot hole 110.

The volume around the pilot hole 110 which encompasses all of the cracks formed in the first surface 104, the second surface 106, and/or the sidewall 116 around each pilot hole 110 can be referred to as a damage zone 120. The damage zone 120 can be defined by an entry diameter D₃ surrounding the pilot hole entry 112, an exit diameter D₄ surround the pilot hole exit 114, and a cross-sectional shape such that the damage zone 120 encompasses all of the cracks extending from the pilot hole 110 along the length of the pilot hole 110. The laser irradiation at step 14 can be controlled to form cracks during formation of the pilot hole 110 such that the entry diameter D₃ of the damage zone 120 is about 200 μm to about 1500 μm, about 200 μm to about 1000 μm, about 200 μm to about 750, about 200 μm to about 500 μm, about 200 μm to about 400 μm, about 400 μm to about 1500 μm, about 400 μm to about 1000 μm, about 400 μm to about 750 μm, about 400 μm to about 500 μm, about 500 μm to about 1500 μm, about 500 μm to about 1000 μm, about 500 μm to about 750 μm, about 750 μm to about 1500 μm, or about 700 μm to about 1000 μm. The exit diameter D₄ of the damage zone 120 is about 50 μm to about 750 μm, about 50 μm to about 500 μm, about 50 μm to about 250 μm, about 50 μm to about 100 μm, about 100 μm to about 750 μm, about 100 μm to about 500 μm, about 100 μm to about 250 μm, about 250 μm to about 500 μm, about 250 μm to about 750 μm, or about 500 μm to about 750 μm.

The cracks can be characterized by a crack diameter corresponding to a width of the crack formed in the first surface 104, the sidewall 116, and/or the second surface 106. It is understood that the cracks can have an irregular shape and dimension along a length of each crack and that the shape and dimensions of each crack may vary according to an aspect of the present disclosure. The cracks may be spaced irregularly or uniformly about the pilot hole 110. In one aspect, a maximum crack diameter along a length of the crack is about 100 nm to greater, about 250 nm or greater, about 500 nm or greater, or about 1000 nm or greater. In one aspect, the cracks in the damage zone 120 are characterized by a maximum crack diameter along the length of the crack that is about 100 nm to about 2000 nm, about 100 nm to about 1000 nm, about 100 nm to about 750 nm, about 100 nm to about 500 nm, about 100 nm to about 250 nm, about 250 nm to about 2000 nm, about 250 nm to about 1000 nm, about 250 nm to about 750 nm, about 250 nm to about 500 nm, about 500 nm to about 2000 nm, about 500 nm to about 1000 nm, about 500 nm to about 750 nm, about 750 nm to about 2000 nm, about 750 nm to about 1000 nm, or about 1000 nm to about 2000 nm. The exact dimensions and shape of the cracks may vary.

The cracks extending radially outward from the pilot hole 110 can be formed by irradiating the first surface 104 with a mid-infrared (mid-IR) or far-infrared (far-IR) laser which outputs a laser beam having at least one wavelength band that is absorbed by the glass substrate 100. In one aspect, irradiating the surface at step 14 includes operating the laser to irradiate the first surface 104 with a laser beam having an output that includes a beam having a wavelength of about 5 μm to about 11 μm. As used herein, a mid-IR laser is defined as a laser that outputs a beam having a wavelength of about 3 μm to about 8 μm and far-IR is defined as wavelengths of about 8 μm to about 15 μm. In one aspect, the laser is a carbon dioxide (CO₂) or a carbon monoxide (CO) laser. According to one example, the laser is a CO₂ laser emitting a beam having a wavelength of 10.6 μm and/or about 9.4 μm. In one example, the laser is a CO laser emitting a wavelength band centering on about Sum.

The laser can be focused onto the first surface 104 through a single lens to form each pilot hole 110. The laser and the optics utilized to focus the laser beam onto the first surface 104 can be configured to provide a Gaussian beam that is irradiated onto the first surface 104. In one aspect, the laser and optical system are configured to form the pilot hole 110 and damage zone 120 with a single exposure through a single lens.

The laser can be operated at step 14 to form the pilot hole 110 and the damage zone 120 having the desired characteristics in concert with the parameters of the subsequent etching process in step 16 based on the desired dimensions of the through hole 102 to be formed. Parameters of the laser irradiation step 14, non-limiting examples of which include the laser power, features of the laser pulse train, and the exposure time, can be configured to form the pilot hole 110 with the damage zone 120 having characteristics suitable for providing the through hole 102 with the desired dimensions based on the parameters of the etching process in step 16. In one aspect, the laser is operated at step 14 at sufficient power to form the pilot hole 110 having a plurality of cracks to form a desired damage zone 120 around the pilot hole 110. The laser can be operated at a power of about 50 Watts to about 100 Watts, about 60 Watts to about 100 Watts, about 80 Watts to about 100 Watts, about 50 Watts to about 80 Watts, or about 60 Watts to about 80 Watts.

In one aspect, the pilot hole 110 and damage zone 120 are formed using a single pulse train. A laser pulse train can be defined based on a pulse length, a waveform duration (also referred to as frequency), and a number of pulses (cycle count) output by the laser. In one aspect, the laser pulse train includes a 90 microsecond (μsec) or less pulse duration, a 100 μsec or greater waveform duration, and a cycle count of 100 or greater. The laser irradiation step 14 can include a single exposure to the laser beam having a duration of about 5 milliseconds (msec) to about 50 msec, about 5 msec to about 40 msec, about 5 msect to about 30 msec, about 5 msec to about 20 msec, about 10 msec to about 50 msec, about 10 msec to about 40 msec, about 10 msec to about 30 msec, about 20 msec to about 50 msec, about 20 msec to about 40 msec, or about 30 msec to about 50 msec.

The laser irradiation step 14 can be repeated multiple times sequentially and/or simultaneously, with one or more lasers to form an array of pilot holes 110 in the glass substrate 100, with each pilot hole 110 in the array having a damage zone 120 according to the present disclosure.

Subsequent to formation of the pilot hole 110 at step 14, the pilot hole 110 is subjected to an etching step 16 to form the through hole 102 having the desired final dimensions and cross-sectional shape. In one aspect, the etching step 16 can include exposing the pilot hole 110 to an etchant that expands the diameter of the pilot hole 110 along the length of the pilot hole 110 to at least encompass the damage zone 120. In this manner, the portions of the glass substrate 100 into which the cracks extend are etched away as the pilot hole 110 is etched. In one aspect, the etchant includes at least one acid or at least one base. Non-limiting examples of suitable acids and bases include hydrofluoric acid (HF), nitric acid (HNO₃), poly(diallyldimethylammonium chloride) (PE), hydrochloric acid (HCl), sodium hydroxide (NaOH). In one aspect, the etchant is an etching solution including a solution of 7.5% by volume (% vol) of HF and 15% vol HNO₃, a solution of 20% vol HF and 0.1% vol PE, a solution of 2.5% vol HF and 5% vol HNO₃, a solution of 5% vol HF and 10% HNO₃, a solution of 10% vol HF and a 20% vol HNO₃, a solution of 3.75% vol HF and 7% vol HNO₃, 20% vol HF solution, a solution of 2.5% vol HNO₃ and 0.01% vol PE, 7.5% vol HF and 20% vol HCl, or a 12 Molar NaOH solution. In one aspect, the etching step 16 can include heating the etching solution prior to or during treatment of the glass substrate 100. The type of etching solution used in the etching step 16, i.e. the components of the etching solution and their respective concentrations, a temperature of the etching solution, and a duration of exposure to the etching solution may vary depending on the materials forming the glass substrate 100, a desired etching rate, and/or the desired final dimensions of the through hole 102 relative to the dimensions of the pilot hole 110 and the damage zone 120.

The glass substrate 100 can be exposed to the etching solution for a predetermined period of time to expand the dimensions of the pilot hole 110 to form a through hole 102 having the desired dimensions and shape. In one aspect, the glass substrate 100 is exposed to the etching solution for about 30 minutes or less, about 25 minutes or less, about 20 minutes or less, about 15 minutes or less, or about 10 minutes or less. In one aspect, the glass substrate 100 is exposed to the etching solution for about 10 minutes to about 30 minutes, about 10 minutes to about 25 minutes, about 10 minutes to about 20 minutes, about 10 minutes to about 15 minutes, about 15 minutes to about 30 minutes, about 15 minutes to about 25 minutes, about 15 minutes to about 20 minutes, or about 20 minutes to about 30 minutes.

According to one aspect, the parameters of the etching step 16, such as the type of etching solution, the optional application of heat, and the length of exposure time to the etching solution, can be selected such that a change in the thickness of the glass substrate 100 before and after the etching step 16 (initial thickness Thᵢₙᵢₜᵢₐₗ-final thickness Th_{final}) is less than about 30%. In one aspect, the change in thickness of the glass substrate 100 is less than about 25%, less than about 20%, less than about 10%, about 5% to about 30%, about 5% to about 25%, about 5% to about 20%, about 5% to about 15%, about 10% to about 30%, about 10% to about 25%, about 10% to about 20%, about 15% to about 30%, about 15% to about 25%, or about 20% to about 30%.

The through hole 102 can be defined by a through hole entry 140 in the first surface 104, a through hole exit 142 in the second surface 106, and a through hole sidewall 144 extending between the through hole entry 140 and the through hole exit 142. A length of the through hole 102 corresponds to the final thickness Th_{final} of the glass substrate 100 after etching at step 16. The through hole entry 140 is defined by an entry diameter D₅ and the through hole exit 142 is defined by an exit diameter D₆, which may be the same or different. According to one aspect, the entry diameter D₅ of the through hole 102 can be 200 μm to about 1.5 mm. In one aspect, the exit diameter D₆ of the through hole 102 can be about 150 μm to about 1 mm. In one aspect, the entry diameter D₅ of the through hole 102 can be about 200 μm to about 1.5 mm, about 200 μm to about 1.25 mm, about 200 μm to about 1 mm, about 200 μm to about 750 μm, about 200 μm to about 500 μm, about 200 μm to about 400 μm, about 250 μm to about 1.5 mm, about 250 μm to about 1.25 mm, about 250 μm to about 1 mm, about 250 μm to about 750 μm, about 250 μm to about 500 μm, about 250 μm to about 400 μm, about 500 μm to about 1.5 mm, about 500 μm to about 1.25 mm, about 500 μm to about 1 mm, about 500 μm to about 750 μm, about 750 μm to about 1.5 mm, about 750 μm to about 1 mm, or about 1 mm to about 1.5 mm. In one aspect the entry diameter D₅ of the through hole 102 is about 200 μm, about 250 μm, about 500 μm, about 1 mm, or about 1.5 mm. According to one aspect, the exit diameter D₆ of the through hole 102 can be about 150 μm to about 750 μm, about 150 μm to about 500 μm, about 150 μm to about 250 μm, about 250 μm to about 1 mm, about 250 μm to about 750 μm, about 250 μm to about 500 μm, about 500 μm to about 1 mm, about 500 μm to about 750 μm, or about 750 μm to about 1 mm, in combination with any of the presently disclosed values or ranges of the entry diameters D₅.

A cross-sectional shape of the through hole 102 can be the same or different than the cross-sectional shape of the pilot hole 110. In one aspect, the etching step 16 may expand the diameter of the pilot hole 110 proportionally along the length of the pilot hole 110 such that the through hole 102 maintains the same cross-sectional shape as the pilot hole 110. In one aspect, the etching step 16 may expand the diameter of the pilot hole 110 non-proportionally along the length of the pilot hole 110 such that the cross-sectional shape of the through hole 102 is different than the cross-sectional shape of the pilot hole 110. It is understood by those in the field that there may be minor variations in hole size between holes formed in the same manner in an array on a single substrate and holes formed in the same manner on different substrates and further that there may be deviations in symmetry in each hole formed and between different holes.

In one aspect, the through hole 102 can be characterized by an X-shaped cross-sectional shape in which a first portion of a sidewall 144 of the through hole 102 extends from the first surface 104 at an angle toward a central axis of the through hole 102 and a second portion of the sidewall 144 extends from the second surface 106 at angle toward the central axis of the through hole 102, such that the first and second portions of the sidewall 144 intersect at an angle or along an arc to form a narrowed portion of the through hole 102. In one aspect, a first angle at which the first portion of the sidewall 144 extends from the first surface 104 and a second angle at which the second portion of the sidewall 144 extends from the second surface 106 may be the same or different, with each of the first angle and the second angle being greater than about 90 degrees, about 90 degrees to about 120 degrees, about 90 degrees to about 110 degrees, about 90 degrees to about 100 degrees, about 90 degrees to about 95 degrees, about 95 degrees to about 120 degrees, about 95 degrees to about 110 degrees, or about 95 degrees to about 100 degree

The parameters of the etching step 16 can be selected to expand the dimensions of the pilot hole 110 to encompass at least the damage zone 120, thereby encompassing the cracks formed by the laser in step 14. In one aspect, expanding the diameter of the pilot hole 110 to encompass the cracks results in a through hole 102 which is substantially free of cracks. As used herein, the term “substantially free” with respect to cracks encompasses the absence of cracks in addition to cracks that may be a result of the natural error in inherent in any manufacturing process. In one aspect, the through hole 102 may be substantially free of cracks having a diameter of sufficient size that renders the through hole 102 unsuitable for its intended purpose. According to one aspect, the through hole 102 may be substantially free of cracks having a diameter greater than 100 nm. In one aspect, the through hole 102 may be substantially free of cracks having a diameter greater than 25 nm, greater than 50 nm, greater than 150 nm, or greater than 200 nm.

Without being limited by any theory, the formation of cracks around the pilot hole 110 is believed to facilitate etching by increasing a surface area of the glass substrate 100 around the pilot hole 110 that is accessible to the etching solution. Increasing accessibility of the glass substrate 100 to the etchant in the area around the pilot hole 110 may increase a rate at which the dimensions of the pilot hole 110 are expanded, thus requiring less exposure time to the etchant to achieve the desired final through hole dimensions. During the etching process the substrate body, in addition to the portions of the substrate defining the pilot hole 110, are exposed to the etchant and will be etched. Etching of the body of the substrate 100 results in some of the bulk of the glass substrate being lost as well as a decrease in the thickness of the glass substrate 100 due to etching. The longer the glass substrate 100 is exposed to the etching solution, the greater the bulk loss, and thus the substrate thickness, will be. The bulk loss can become particularly challenging when forming large through holes having a diameter of about 200 μm to about 1.5 mm, as larger holes require higher etchant concentrations and/or longer exposure time than smaller holes, which results in an increase the bulk loss during etching as the final desired dimensions of the through hole 102 increase.

The method according to the present disclosure forms the pilot hole 110 with a plurality of radially extending cracks which are believed to increase the rate at which the dimensions of the pilot hole 110 are expanded during the etching process. Increases in the etching rate can decrease the exposure time and/or etchant strength required to expand the pilot hole 110 to a desired final dimension compared to processes which do not form cracks around the pilot hole 110. Decreasing exposure time to the etchant according to the present disclosure can decrease the loss of substrate material due to etching, which can decrease waste and may also allow for the use of substrates having a smaller initial thickness.

The parameters of the etching step 16, such as the type of etching solution, the optional application of heat, and the length of exposure time to the etching solution, can be selected in concert with the parameters of the laser irradiation step 14 to provide a through hole 102 having the desired dimensions. For example, the dimensions of the pilot hole 110 and the extent of cracking defining the damage zone 120 relative to the desired final dimensions of the through hole 102 can be determined experimentally and/or theoretically based on achieving a predetermined etching time and/or based on a desired thickness loss for a given substrate material. In this manner, the methods of the present disclosure can be utilized to increase a rate at which large through holes, i.e., through holes having a diameter of about 200 μm to about 1.5 mm, can be formed. In another example, parameters of the etching process in step 16 can be set based on the substrate material and to maintain the substrate thickness loss below a predetermined threshold. The parameters of the laser irradiation step 14 can then be modified to provide a pilot hole 110 with cracks defining a damage zone 120 having dimensions that will provide a through hole 102 having the desired final dimensions based on the set etching process parameters.

The methods of the present disclosure can provide additional benefits with respect to the type of optical systems that can be used to form arrays of through holes according to the present disclosure. For example, many prior art laser ablation methods utilize multiple lenses and/or complex lenses, such as axicon lenses, to form through holes that are free of cracks and/or free of residual stresses that can produce cracks. Some prior art methods utilize high heat during laser ablation to relax the glass and thereby form through holes that are free of cracks. In addition, many prior art laser ablation processes utilize multiple laser exposures in order to form the through hole, rather than the single laser exposure of the present disclosure. Utilizing multiple laser exposures requires the use of a scanning system, such as a galvanometer scanning system, to control the laser beam direction. The methods of the present disclosure can be implemented with a static laser system and thus multiple lasers could be utilized at the same time to form an array of through holes and decrease production time.

For example, a single laser operating according to the methods of the present disclosure with a 10 ms exposure time and a 2 meter per second stage travel time can form 100,000 holes in a 500 mm by 500 mm substrate in 20 minutes. A conventional process utilizing an ultrafast visible or near-IR laser to create the same array of holes can take 15 minutes or more. However, because the methods of the present disclosure can be implemented with a static laser system, multiple lasers can be utilized at the same time to form the array of holes and decrease the processing time. For example, the methods of the present disclosure can be implemented using two lasers to cut laser processing time down to 10 minutes or ten lasers to decrease laser processing time down to 2 minutes.

### EXAMPLES

The following examples describe various features and advantages provided by the disclosure, and are in no way intended to limit the aspects of the present disclosure and appended claims.

### Example 1

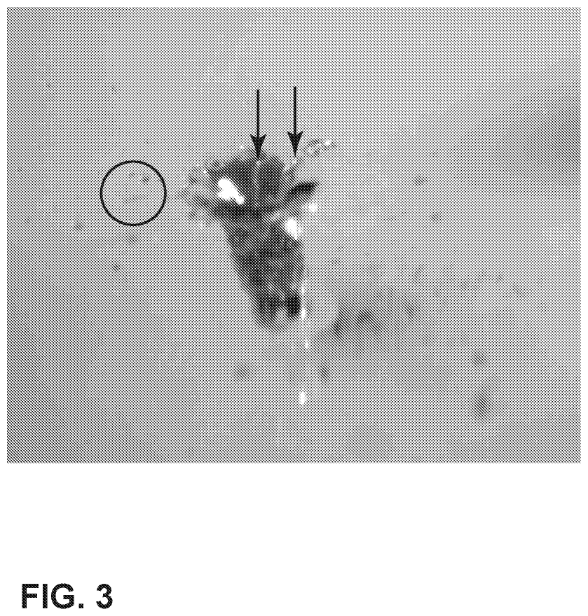

FIG. 3 is an image of a pilot hole having a plurality of radially extending cracks (arrows in image) formed in a glass substrate using a CO₂ laser. The substrate was a 500 mm by 500 mm piece of Corning® Gorilla® Glass having a thickness of 1.1 mm. The CO₂ laser emitted a beam having a wavelength of 10.6 μm. The laser was operated at a power of 80 Watts and a pulse train of 50 μsec pulse, a 100 μsec waveform, and a 200n cycle count. The exposure time to the laser pulse train was 10 ms. The image was taken with a camera at 12× magnification. The reference circle shown in the image has a diameter of 300 μm.

### Example 2

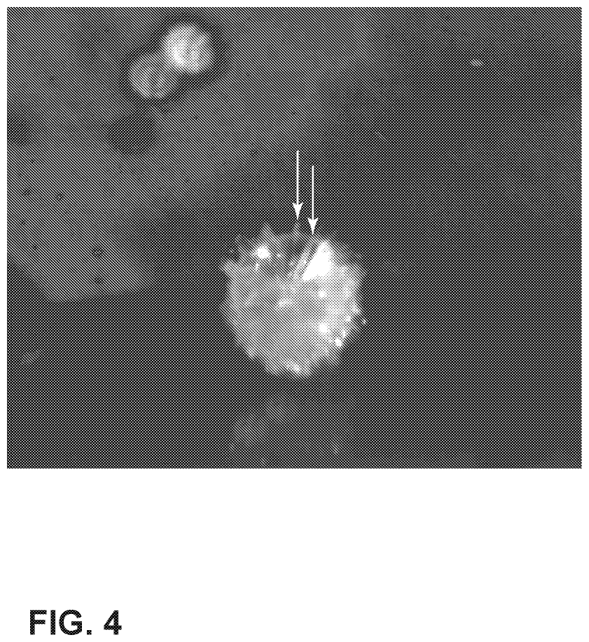

FIG. 4 is an image of a pilot hole having a plurality of radially extending cracks (arrows in image) formed in a glass substrate using a CO₂ laser. The substrate was a 500 mm by 500 mm piece of soda lime glass having a thickness of 1.1 mm. The CO₂ laser emitted a beam having a wavelength of 10.6 μm. The laser was operated at a power of 80 Watts and a pulse train of a 50 μsec pulse, a 100 μsec waveform, and a 200n cycle count. The exposure time to the laser pulse train was 50 msec. The image was taken with a camera 12× magnification.

### Comparative Example 1

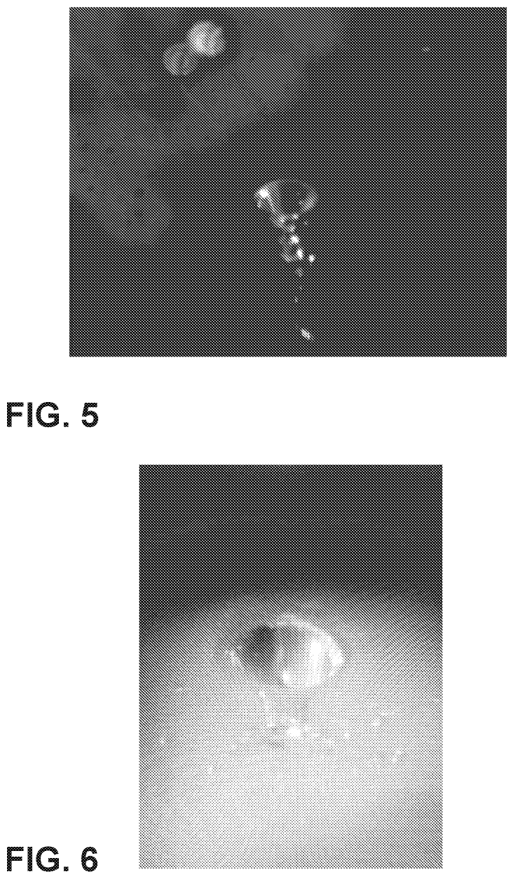

FIGS. 5 and 6 are images of comparative pilot holes formed using laser ablation that are free of cracks. FIG. 5 is an image of a comparative pilot hole formed in a 500 mm by 500 mm piece of boro-aluminosilicate glass having a thickness of 0.5 mm. The laser was a CO₂ laser operated to emit a beam having a wavelength of 10.6 μm. The laser was operated at a power of 50 Watts and a pulse train of a 50 μsec pulse, a 100 μsec waveform, and a 1,000n cycle count. The exposure time to the laser pulse train was 100 msec. The image was taken with a camera at 12× magnification.

FIG. 6 is an image of a comparative pilot hole formed in a 500 mm by 500 mm piece of boro-aluminosilicate glass having a thickness of 0.5 mm. The laser was a CO₂ laser operated to emit a beam having a wavelength of 10.6 μm. The laser was operated at a power of 50 Watts and a pulse train of a 50 μsec pulse, a 200 μsec waveform, and a 200n cycle count. The exposure time to the laser pulse train was 40 msec. The image was taken with a camera at 12× magnification.

### Example 3

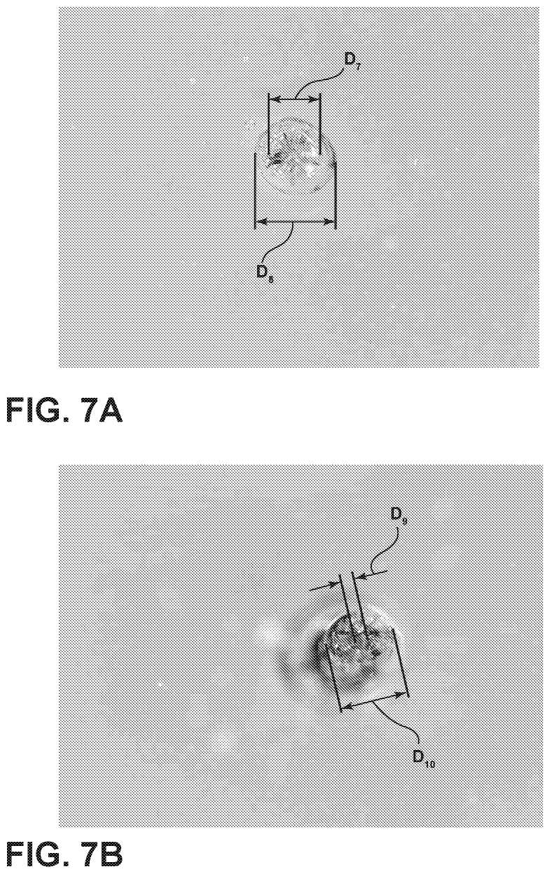

FIGS. 7A and 7B are top-down and bottom up views, respectively, of a pilot hole having a plurality of radially extending cracks. The substrate is a 500 mm by 500 mm piece of Corning® Gorilla® Glass 5 having a thickness of 1.1 mm. The laser was a CO₂ laser operated to emit a beam having a wavelength of 10.6 μm. The laser was operated at a power of 80 Watts and a pulse train of 50 μsec pulse, a 100 μsec waveform, and a 200 cycle count. The exposure time to the laser pulse train was 10 ms. The image was taken with a camera at 12× magnification. As shown in FIG. 7A, the pilot hole is characterized by an entry diameter D₇ of about 373 μm and a damage zone around the pilot hole entry having a diameter D₈. FIG. 7B shows the pilot hole exit, which is characterized by an exit diameter D₉ of about 65 μm and a damage zone around the pilot exit having a diameter D₁₀.

### Example 4

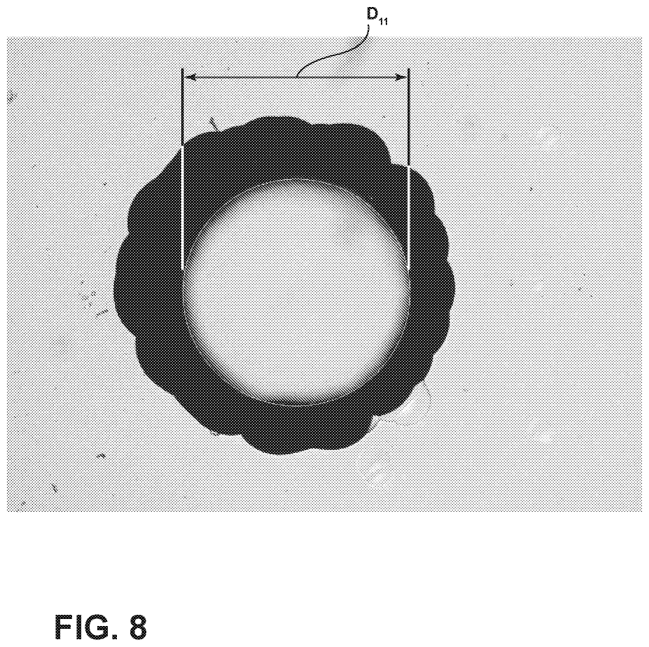

FIG. 8 is an image of a through hole formed by etching a pilot hole having a plurality of radially extending cracks. The substrate was a 500 mm by 500 mm piece of Corning® Gorilla® Glass having a thickness of 1.1 mm. The CO₂ laser emitted a beam having a wavelength of 10.6 μm. The laser was operated at a power of 80 Watts and a pulse train of 50 μsec pulse, a 100 μsec waveform, and a 200n cycle count. The exposure time to the laser pulse train was 10 ms.

The pilot hole was exposed to an etching solution including 7.5% vol HF and 15% vol HNO₃ at 20° C. for 30 minutes. The resulting through hole is shown in FIG. 8 and is characterized by an entry diameter D₁₁ of about 514 μm. FIG. 8 demonstrates that the through hole is free of radially extending cracks, which were removed during the etching process. The thickness of the glass substrate after etching was about 0.9 mm, thus exhibiting a bulk loss of only about 20%. The image was taken with a camera at 12× magnification.

### Example 5

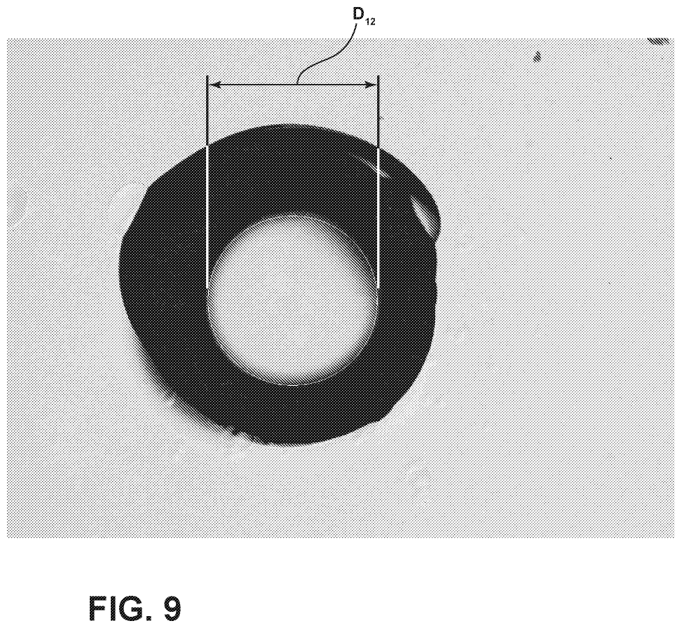

FIG. 9 is an image of a through hole formed by etching a pilot hole having a plurality of radially extending cracks. The through hole in FIG. 9 was formed in a manner similar to that of FIG. 8, except that a different laser waveform was used. The substrate was a 500 mm by 500 mm piece of Corning® Gorilla® Glass having a thickness of 1.1 mm. The CO₂ laser emitted a beam having a wavelength of 9.3 μm. The laser was operated at a power of 80 Watts and a pulse train of a 50 μsec pulse, a 100 μsec waveform, and a 200n cycle count. The exposure time to the laser pulse train was 10 ms.

The pilot hole was exposed to an etching solution including 7.5% vol HF and 15% vol HNO₃ at 20° C. for 30 minutes. The resulting through hole is shown in FIG. 9 and is characterized by an entry diameter D₁₂ of about 365 μm and is free of radially extending cracks. FIG. 9 demonstrates that the laser pulse train can be modified to form through holes having different dimensions without changing the etching process. The image was taken with a camera at 12× magnification.

### Example 6

One conventional process for forming an array of 250 μm through holes includes irradiation with a visible (523 nm) or near-IR (1030 nm) ultrafast laser followed by an etching process. An array of 100,000 pilot holes, free of cracking, can typically be formed in a 500 mm by 500 mm piece of Corning® Gorilla® Glass having a thickness of 1.1 mm using this conventional process in about 15 minutes. The conventional pilot holes can then be etched for 1-2 hours in an etching solution including 7.5% vol HF and 15% vol HNO₃ at 20° C. to form through holes having an entry diameter of about 250 μm. The bulk loss of the substrate after etching in this conventional process is typically about 40%.

As discussed above in Example 4, the same etching solution, 7.5% vol HF and 15% vol HNO₃ at 20° C., can be used to form a through hole according to the present disclosure having an entry diameter of about 514 μm in less time than the conventional process takes to form a through hole having half the diameter. The bulk loss for the sample in Example 4 is about 20%, which is about half the bulk loss exhibited by the conventional process in making through holes having a smaller entry diameter. In another example, through holes were made in the same manner as those in Example 4, except for a 15 minute etchant exposure rather than a 30 minute exposure, to form through holes having an entry diameter of about 250 μm and a bulk loss of only about 10%. These examples demonstrate the ability of the methods of the present disclosure to form through holes with less bulk loss due to etching compared to other conventional methods that utilize a combination of laser pilot hole drilling and etching.

The following non-limiting aspects are encompassed by the present disclosure:

According to a first aspect of the present disclosure, a method of forming a through hole in a glass substrate includes providing a glass substrate having a first surface, a second surface, and a thickness extending between the first surface and the second surface. The first surface is irradiated with a mid-infrared or far-infrared laser to form a pilot hole extending between the first surface and the second surface. The glass substrate includes a plurality of cracks extending radially outward from the pilot hole. The method includes etching the pilot hole to expand a diameter of the pilot hole to at least encompass the plurality of cracks extending radially outward from the pilot hole. The etched pilot hole forms a through hole having a through hole entry diameter of about 200 micrometers to about 1.5 millimeters.

According to the first aspect of the present disclosure, the glass substrate is free of cracks having a crack diameter greater than about 100 nm extending radially outward from the through hole.

According to the first aspect or any intervening aspects, the glass substrate is substantially free of cracks extending radially outward from the through hole.

According to the first aspect or any intervening aspects, the step of irradiating the first surface with a mid-infrared or far-infrared laser includes operating the laser at a power of about 50 Watts to about 100 Watts.

According to the first aspect or any intervening aspects, the step of irradiating the first surface with a mid-infrared or far-infrared laser includes operating the laser at a power of about 80 Watts to about 100 Watts.

According to the first aspect or any intervening aspects, the step of irradiating the first surface with a mid-infrared or far-infrared laser includes operating the laser at a wavelength of about 5 micrometers to about 11 micrometers.

According to the first aspect or any intervening aspects, the laser includes a carbon dioxide laser or a carbon monoxide laser.

According to the first aspect or any intervening aspects, the step of irradiating the first surface with a mid-infrared or far-infrared laser includes focusing a laser beam onto the first surface through a single lens.

According to the first aspect or any intervening aspects, the step of irradiating the first surface with a mid-infrared or far-infrared laser includes irradiating the first surface with a Gaussian beam.

According to the first aspect or any intervening aspects, the step of irradiating the first surface with a mid-infrared or far-infrared laser includes a single exposure to a laser beam.

According to the first aspect or any intervening aspects, the single exposure has a duration of about 5 milliseconds to about 50 milliseconds.

According to the first aspect or any intervening aspects, the step of irradiating the first surface with a mid-infrared or far-infrared laser includes operating the laser to emit a pulse train including: a 90 microsecond or less pulse duration, a 100 microsecond or greater waveform duration, and a cycle count of 100 or greater.

According to the first aspect or any intervening aspects, the pilot hole is characterized by at least one of a pilot hole entry diameter of about 150 micrometers to about 1000 micrometers and a pilot hole exit diameter of about 50 micrometers to about 500 micrometers.

According to the first aspect or any intervening aspects, the through hole is further characterized by a through hole exit diameter of about 150 micrometers to about 1 millimeter.

According to the first aspect or any intervening aspects, the step of etching the pilot hole includes treating the glass substrate with an etching solution comprising an acid or a base.

According to the first aspect or any intervening aspects, the etching solution includes at least one of hydrofluoric acid, nitric acid, poly(diallyldimethylammonium chloride), hydrochloric acid, sodium hydroxide, or combinations thereof.

According to the first aspect or any intervening aspects, the step of etching the pilot hole further includes heating the etching solution.

According to the first aspect or any intervening aspects, the thickness of the glass substrate is about 0.4 millimeters to about 3 millimeters.

According to the first aspect or any intervening aspects, the step of etching the pilot hole is characterized by a change in the thickness of the glass substrate of about 30% or less.

According to the first aspect or any intervening aspects, the glass includes at least one of chemically strengthened glass, soda lime glass, alkali aluminosilicate glass, germanium glass, alkaline earth boro-aluminosilicate glass, alkali borosilicate glass, calcium fluoride glass, and magnesium fluoride glass.

According to the first aspect or any intervening aspects, the step of etching the pilot hole includes exposing the glass substrate to an etching solution for about 30 minutes or less.

According to a second aspect of the present disclosure, a method of forming an array of through holes in a glass substrate according to the method of the first aspect or any of the intervening aspects includes repeating the step of irradiating the first surface with a mid-infrared or far-infrared laser to form an array of pilot holes extending between the first surface and the second surface. The glass substrate includes a plurality of cracks extending radially outward from each of the pilot holes. The array of pilot holes is etched to expand a diameter of each of the pilot holes to at least encompass the plurality of cracks extending radially outward from each of the pilot holes. The etched array of pilot holes forms an array of through holes, wherein each through hole is characterized by a through hole entry diameter of about 200 micrometers to about 1.5 millimeters.

Many variations and modifications may be made to the above-described embodiments of the disclosure without departing substantially from the spirit and various principles of the disclosure. All such modifications and variations are intended to be included herein within the scope of this disclosure and protected by the following claims.

1. A method of forming a through hole in a glass substrate, comprising:
providing a glass substrate having a first surface, a second surface, and a thickness extending between the first surface and the second surface;
irradiating the first surface with a mid-infrared or far-infrared laser to form a pilot hole extending between the first surface and the second surface, the glass substrate comprising a plurality of cracks extending radially outward from the pilot hole; and
etching the pilot hole to expand a diameter of the pilot hole to at least encompass the plurality of cracks extending radially outward from the pilot hole;
wherein the etched pilot hole forms a through hole characterized by a through hole entry diameter of about 200 micrometers to about 1.5 millimeters.

2. The method of claim 1, wherein the glass substrate is free of cracks having a crack diameter greater than about 100 nm extending radially outward from the through hole.

3. The method of claim 1, wherein the glass substrate is substantially free of cracks extending radially outward from the through hole.

4. The method of claim 1, wherein the step of irradiating the first surface with a mid-infrared or far-infrared laser comprises operating the laser at a power of about 50 Watts to about 100 Watts.

5. The method of claim 1, wherein the step of irradiating the first surface with a mid-infrared or far-infrared laser comprises operating the laser at a power of about 80 Watts to about 100 Watts.

6. The method of claim 1, wherein the step of irradiating the first surface with a mid-infrared or far-infrared laser comprises operating the laser at a wavelength of about 5 micrometers to about 11 micrometers.

7. The method of claim 1, wherein the laser comprises a carbon dioxide laser or a carbon monoxide laser.

8. The method of claim 1, wherein the step of irradiating the first surface with a mid-infrared or far-infrared laser comprises focusing a laser beam onto the first surface through a single lens.

9. The method of claim 1, wherein the step of irradiating the first surface with a mid-infrared or far-infrared laser comprises irradiating the first surface with a Gaussian beam.

10. The method of claim 1, wherein the step of irradiating the first surface with a mid-infrared or far-infrared laser comprises a single exposure to a laser beam.

11. The method of claim 10, wherein the single exposure has a duration of about 5 milliseconds to about 50 milliseconds.

12. The method of claim 1, wherein the step of irradiating the first surface with a mid-infrared or far-infrared laser comprises operating the laser to emit a pulse train comprising:
a 90 microsecond or less pulse duration;
a 100 microsecond or greater waveform duration; and
a cycle count of 100 or greater.

13. The method of claim 1, wherein the pilot hole is characterized by at least one of:
a pilot hole entry diameter of about 150 micrometers to about 1000 micrometers; and
a pilot hole exit diameter of about 50 micrometers to about 500 micrometers.

14. The method of claim 1, wherein the through hole is further characterized by a through hole exit diameter of about 150 micrometers to about 1 millimeter.

15. The method of claim 1, wherein the step of etching the pilot hole comprises treating the glass substrate with an etching solution comprising an acid or a base.

16. The method of claim 15, wherein the etching solution comprises at least one of hydrofluoric acid, nitric acid, poly(diallyldimethylammonium chloride), hydrochloric acid, sodium hydroxide, or combinations thereof.

17. The method of claim 15, wherein the step of etching the pilot hole further comprises heating the etching solution.

18. The method of claim 1, wherein the thickness of the glass substrate is about 0.4 millimeters to about 3 millimeters.

19. The method of claim 1, wherein the step of etching the pilot hole is characterized by a change in the thickness of the glass substrate of about 30% or less.

20. A method of forming an array of through holes in a glass substrate according to the method of claim 1, comprising:
repeating the step of irradiating the first surface with a mid-infrared or far-infrared laser to form an array of pilot holes extending between the first surface and the second surface, the glass substrate comprising a plurality of cracks extending radially outward from each of the pilot holes; and
etching the array of pilot holes to expand a diameter of each of the pilot holes to at least encompass the plurality of cracks extending radially outward from each of the pilot holes;
wherein the etched array of pilot holes forms an array of through holes, wherein each through hole is characterized by a through hole entry diameter of about 200 micrometers to about 1.5 millimeters.
